(19) United States
(12) Patent Application Publication
(10) Pub. No.: US 2008/0048769 A1
(43) Pub. Date: Feb. 28, 2008

(54) Balance compensation circuit for multi-power-output voltage

(75) Inventor: Jian-Ying Li, Taoyuan Hsien (TW)

Correspondence Address: Haverstock & Owens LLP, 162 North Wolfe Road, Sunnyvale, CA, 94086, US

(73) Assignee: Delta Electronics, Inc.

(21) Appl. No.: 11/895,509

(22) Filed: Aug. 24, 2007

(30) Foreign Application Priority Data
Aug. 24, 2006 (TW) 95131210

(51) Int. Cl. G05F 1/10; G05F 3/02

(52) U.S. Cl. 327/538

(57) ABSTRACT

A balance compensation circuit for multi-power-output voltage is provided. The voltage balance compensation circuit comprises a ground terminal; a first output terminal providing a first output voltage; a first capacitor electrically connected between the first output terminal and the ground terminal and filtering the first output voltage; a second output terminal providing a second output voltage; a second capacitor electrically connected between the second output terminal and the ground terminal and filtering the second output voltage; a diode electrically connected between the first and the second output terminals and modulating a voltage difference between the first and the second output voltages by using a forward bias thereof; and a resistor electrically connected between the first and the second output terminals, serially connected to the diode, and having a resistance for assisting the modulation of the diode.

### FIELD OF THE INVENTION

The present invention relates to a balance compensation circuit, and more particular to a balance compensation circuit for multi-power-output voltage.

### BACKGROUND OF THE INVENTION

Please refer to FIG. 1, which shows a circuit diagram of the conventional multi-power-output voltage circuit, wherein the power-output voltage circuit 10 is composed of two filtering capacitors C1, C2 and a diode D. The first output terminal A connected to the first filtering capacitor C₁ outputs a first output voltage Vₒᵤₜ₁ which is filtered by the first filtering capacitor C₁, and the second output terminal B connected to the second filtering capacitor C₂ outputs a second output voltage Vₒᵤₜ₂ which is filtered by the second filtering capacitor C₂.

For balancing the first and the second outputting voltages Vₒᵤₜ₁, Vₒᵤₜ₂, the voltage difference between the two output voltages Vₒᵤₜ₁, Vₒᵤₜ₂ is adjusted by using the forward bias of the diode D therebetween in the conventional technique. The adjusting methods are illustrated below.

In FIG. 1, I₁ is defined as a first rectifying output current at the front end of the first output terminal A, Iₒᵤₜ₁ is defined as a first output current, I_{D} is defined as a current flowing through the diode D, I₂ is defined as a second rectifying output current at the front end of the second output terminal B, and Iₒᵤₜ₂ is defined as a second output current.

Each output voltage in FIG. 1 is affected by the elements' inaccuracies and the output currents caused by the voltage output of the switch power, so that each of the first output voltage Vₒᵤₜ₁ and the second output voltage Vₒᵤₜ₂ falls within a range respectively. Please refer to FIG. 2, which shows the variation ranges of the first output voltage and the second output voltage in the circuit of FIG. 1. In FIG. 2, V₁⁺ is defined as the upper limit of the first output voltage Vₒᵤₜ₁ and V₁⁻ is defined as the lower limit thereof. V2⁺ is defined as the upper limit of the second output voltage Vₒᵤₜ₂ and V₂⁻ is defined as the lower limit thereof. ΔV is defined as the voltage difference between the two output voltages. The voltage difference ΔV between the two output voltages can be adjusted by using the diode D.

In this situation, when the voltage difference ΔV reaches the switch-on voltage of the diode D, the diode D will be switched on. However, because of the voltage/current properties of the diode (as shown in FIG. 3, wherein the voltage V_{D} of the diode D is shown on the cross axle, and the current I_{D} of the diode D is shown on the vertical axle), after the diode D is switched on, if the voltage difference ΔV is slightly increased, the current I_{D} through the diode will be greatly increased. This results in a temperature increase of the diode D, and even destroys it. For the second output terminal, Iₒᵤₜ₂=I₂+I_{D}, and usually, while the over current protection for the output of the second current output Iₒᵤₜ₂ is performed, the second rectifying current output I₂ is detected. Once the current I_{D} of the diode D is close to or larger than the second rectifying current output I₂, the precision of the over current protection will be significantly decreased.

As above-mentioned, in order to protect the diode and make the voltage output smooth, a balance compensation circuit for multi-power-output voltage is provided in the present invention.

### SUMMARY OF THE INVENTION

In accordance with a main aspect of the present invention, a balance compensation circuit for multi-power-output voltage is provided, which can effectively adjust a voltage difference among the multiple output voltages of the power switches for avoiding the possible component damage.

According to the main aspect of the present invention, a serially connected resistor is disposed with the diode of the original multi-power-output voltage circuit, which adjusts the voltage difference between the two output voltages by using the forward bias of the diode and the resistance of the resistor. Moreover, using the resistor for controlling the current following through the diode can make the controlling of the range of the voltage difference easier.

According to the first aspect of the prevent invention, a voltage balance compensation circuit is provided, comprising a ground terminal; a first output terminal providing a first output voltage; a first capacitor electrically connected between the first output terminal and the ground terminal and filtering the first output voltage; a second output terminal providing a second output voltage; a second capacitor electrically connected between the second output terminal and the ground terminal and filtering the second output voltage; a diode electrically connected between the first and the second output terminals and modulating a voltage difference between the first and the second output voltages by using a forward bias thereof; and a resistor electrically connected between the first and the second output terminals, serially connected to the diode, and having a resistance for assisting the modulation of the diode.

Preferably, the voltage balance compensation circuit is applied to a multi-power-output circuit.

According to the second aspect of the prevent invention, a voltage balance compensation circuit is provided, comprising a first power-output voltage circuit; a second power-output voltage circuit; a diode circuit comprising at least a diode and electrically connected between the first and the second power-output voltage circuits for modulating a voltage difference therebetween by using a forward bias thereof; and a resistance circuit comprising at least a resistor, electrically connected between the first and the second power-output voltage circuits, serially connected to the diode and having a resistance for assisting the modulation of the diode.

Preferably, the voltage balance compensation circuit is applied to a multi-power-output circuit.

Preferably, the first power-output voltage circuit comprises a ground terminal; a first output terminal providing a first output voltage; and a first filter circuit electrically connected between the first output terminal and the ground terminal and filtering the first output voltage.

Preferably, the first filter circuit comprises at least a first capacitor.

Preferably, the second power-output voltage circuit comprises a second output terminal providing a second output voltage; and a second filter circuit electrically connected between the second output terminal and the ground terminal and filtering the second output voltage.

Preferably, the second filter circuit comprises at least a second capacitor.

Preferably, the diode circuit comprises at least two coupled diodes.

Preferably, the coupled diodes are serially connected.

Preferably, the resistance circuit comprises at least two coupled resistors.

Preferably, the coupled resistors are serially connected.

According to the third aspect of the prevent invention, a voltage balance compensation circuit is provided, comprising a plurality of power-output voltage circuits each of which comprises an output terminal for providing an output voltage; and a circuit having a diode circuit and a resistance circuit serially connected and electrically connected between two of the respective output terminals, wherein a voltage difference between two of the respective output voltages is modulated by a forward bias of the diode circuit by a resistance of the resistor.

Preferably, the voltage balance compensation circuit is applied to a multi-power-output circuit.

Preferably, each of the power-output voltage circuits comprises a ground terminal; and a filter circuit electrically connected between the output terminal and the ground terminal and filtering the output voltage.

Preferably, each filter circuit comprises at least a capacitor.

Preferably, each diode circuit comprises at least two coupled diodes.

Preferably, the coupled diodes are serially connected.

Preferably, the resistance circuit comprises at least two coupled resistors.

Preferably, the coupled resistors are serially connected.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a circuit diagram showing the conventional multi-power-output voltage circuit;

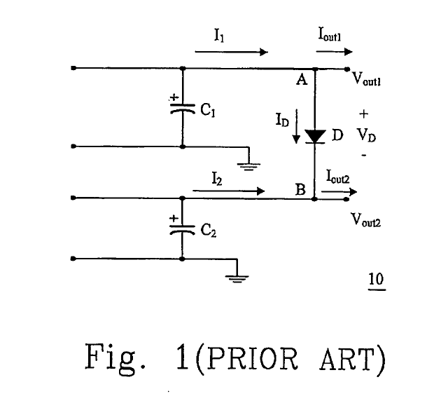

FIG. 2 is a diagram showing the variation ranges of the first and second output voltages in FIG. 1;

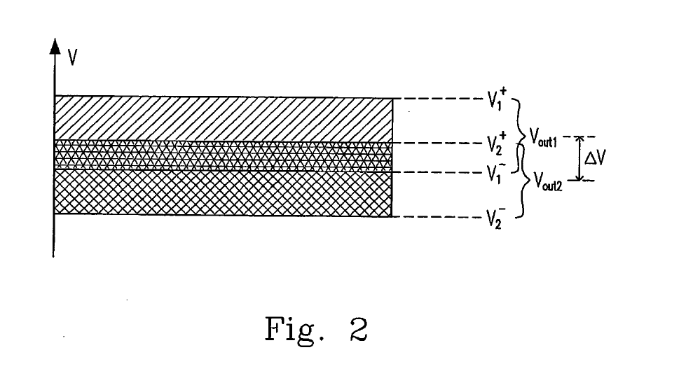

FIG. 3 is a voltage-current diagram of the diode of the circuit in FIG. 1;

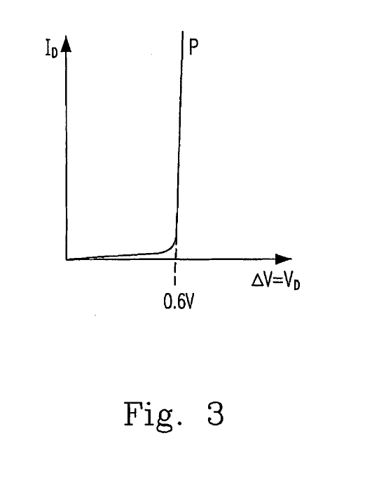

FIG. 4 is a circuit diagram showing the balance compensation circuit for multi-power-output voltage according to a preferred embodiment of the present invention; and

FIG. 5 is a voltage-current diagram of the diode of the circuit in FIG. 4.

### DETAILED DESCRIPTION OF THE PREFERRED EMBODIMENT

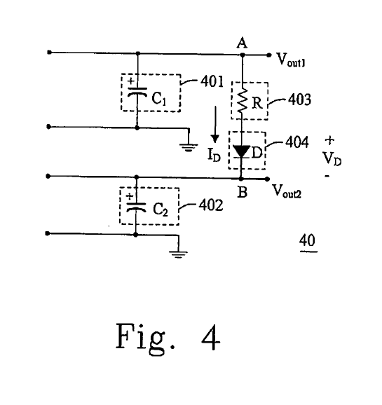

Please refer to FIG. 4, which shows the balance compensation circuit for multi-power-output voltage according to a preferred embodiment of the present invention. In FIG. 4, the balance compensation circuit 40 is composed of the first voltage output terminal A, the second voltage output terminal B, the first filtering capacitor C₁, the second filtering capacitor C₂, the diode D and the resistor R. The first power-output voltage circuit is composed of the first voltage output terminal A and the first filtering capacitor C₁, wherein the power is filtered by the first filtering capacitor C₁ and then outputted through the first voltage output terminal A as the first output voltage Vₒᵤₜ₁. The second power-output voltage circuit is composed of the second voltage output terminal A and the second filtering capacitor C₂, wherein the power is filtered by the second filtering capacitor C₂ and then outputted through the second voltage output terminal A as the second output voltage Vₒᵤₜ₂.

The main technical feature of the present invention is to connect the resistor R in series with the diode D between the first voltage output terminal A and the second voltage output terminal B, which uses the resistance of the resistor R to assist the diode D in using its forward bias to adjust the voltage difference between the first output voltage Vₒᵤₜ₁ and the second output voltage Vₒᵤₜ₂. Since the resistance of the resistor R can resist the current, the current difference between the two voltage output terminals can be adjusted, and the current flowing through the diode D can also be controlled through the resistor R. Therefore, it is easier to control the adjusting rang of the voltage difference.

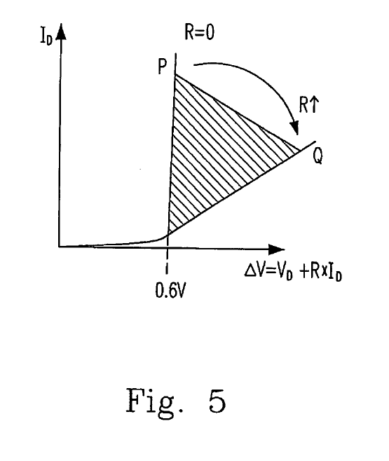

Please refer to FIG. 5, which shows the voltage-current diagram of the diode of the circuit in FIG. 4, wherein the voltage difference ΔV between the first output voltage Vₒᵤₜ₁ and the second output voltage Vₒᵤₜ₂ is shown on the cross axle (which equals to the sum of the voltage V_{D} of the diode D and the voltage on the resistor R R×I_{D}), and the current I_{D} of the diode D is shown on the vertical axle. When the resistance of the resistor R is adjusted from low to high starting from zero, the voltage-current curve P of the diode will gradually change to the curve Q with a low slope. Accordingly, for the skilled person in this field, the balance current between the two output voltages Vₒᵤₜ₁ and Vₒᵤₜ₂ can be adjusted to the desired curve of the balance voltage difference and current for achieving a voltage balance effect according to the resistance of the resistor R, the number of the serially connected diodes and the corresponding model thereof. Simultaneously, the diode D is under protection because of the serially connected resistor R.

Therefore, besides the disposition of the single resistor R and the single diode D in FIG. 4, the resistor R can also be replaced by a resistance circuit 403, which is composed of at least two coupled resistors, and certainly, the phrase “coupled” here generally means “serially connected”. Similarly, the diode D can also be replaced by a diode circuit 404, which is composed of at least two coupled diodes, wherein the phrase “coupled” here also means “serially connected”.

In another aspect, for the skilled person in this field, the single filtering capacitors C₁ and C₂ also can be regarded as two filtering circuits 401, 402, as long as the filtering circuits can perform the normal filtering function.

The above descriptions focus on applying the balance compensation circuit of the present invention between two power-output voltages. However, for the skilled person in this field, the present invention can also be applied among three power-output voltages or more, as long as the balance compensation circuits of the present invention are applied between two of these power-output voltages.

To sum up, a balance compensation circuit for multi-power-output voltage is provided, which adjusts the relation curve of the output voltage difference and the current by serially connecting one or more diodes to the resistances for adjusting a voltage difference among the multi-output voltages of the power switches and avoiding the component damage in the circuit.

While the application has been described in terms of what are presently considered to be the most practical and preferred embodiments, it is to be understood that the application need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present application which is defined by the appended claims.

What is claimed is:

1. A voltage balance compensation circuit, comprising:
a ground terminal;
a first output terminal providing a first output voltage;
a first capacitor electrically connected between the first output terminal and the ground terminal and filtering the first output voltage;
a second output terminal providing a second output voltage;
a second capacitor electrically connected between the second output terminal and the ground terminal and filtering the second output voltage;
a diode electrically connected between the first and the second output terminals and modulating a voltage difference between the first and the second output voltages by using a forward bias thereof; and
a resistor electrically connected between the first and the second output terminals, serially connected to the diode, and having a resistance for assisting the modulation of the diode.

2. A voltage balance compensation circuit as claimed in claim 1 being applied to a multi-power-output circuit.

3. A voltage balance compensation circuit, comprising:
a first power-output voltage circuit;
a second power-output voltage circuit;
a diode circuit comprising at least a diode and electrically connected between the first and the second power-output voltage circuits for modulating a voltage difference therebetween by using a forward bias thereof; and
a resistance circuit comprising at least a resistor, electrically connected between the first and the second power-output voltage circuits, serially connected to the diode and having a resistance for assisting the modulation of the diode.

4. A voltage balance compensation circuit as claimed in claim 3 being applied to a multi-power-output circuit.

5. A voltage balance compensation circuit as claimed in claim 3, wherein the first power-output voltage circuit comprises:
a ground terminal;
a first output terminal providing a first output voltage; and
a first filter circuit electrically connected between the first output terminal and the ground terminal and filtering the first output voltage.

6. A voltage balance compensation circuit as claimed in claim 5, wherein the first filter circuit comprises at least a first capacitor.

7. A voltage balance compensation circuit as claimed in claim 3, wherein the second power-output voltage circuit comprises:
a second output terminal providing a second output voltage; and
a second filter circuit electrically connected between the second output terminal and the ground terminal and filtering the second output voltage.

8. A voltage balance compensation circuit as claimed in claim 7, wherein the second filter circuit comprises at least a second capacitor.

9. A voltage balance compensation circuit as claimed in claim 3, wherein the diode circuit comprises at least two coupled diodes.

10. A voltage balance compensation circuit as claimed in claim 9, wherein the coupled diodes are serially connected.

11. A voltage balance compensation circuit as claimed in claim 3, wherein the resistance circuit comprises at least two coupled resistors.

12. A voltage balance compensation circuit as claimed in claim 11, wherein the coupled resistors are serially connected.

13. A voltage balance compensation circuit, comprising:
a plurality of power-output voltage circuits each of which comprises an output terminal for providing an output voltage; and
a circuit having a diode circuit and a resistance circuit serially connected and electrically connected between two of the respective output terminals,
wherein a voltage difference between two of the respective output voltages is modulated by a forward bias of the diode circuit by a resistance of the resistor.

14. A voltage balance compensation circuit as claimed in claim 13 being applied to a multi-power-output circuit.

15. A voltage balance compensation circuit as claimed in claim 13, wherein each of the power-output voltage circuits comprises:
a ground terminal; and
a filter circuit electrically connected between the output terminal and the ground terminal and filtering the output voltage.

16. A voltage balance compensation circuit as claimed in claim 15, wherein each filter circuit comprises at least a capacitor.

17. A voltage balance compensation circuit as claimed in claim 13, wherein each diode circuit comprises at least two coupled diodes.

18. A voltage balance compensation circuit as claimed in claim 17, wherein the coupled diodes are serially connected.

19. A voltage balance compensation circuit as claimed in claim 13, wherein the resistance circuit comprises at least two coupled resistors.

20. A voltage balance compensation circuit as claimed in claim 19, wherein the coupled resistors are serially connected.
